(19) United States
(12) Patent Application Publication
(10) Pub. No.: US 2010/0236827 A1
(43) Pub. Date: Sep. 23, 2010

(54) WIRING HARNESS AND METHOD OF FORMING A WIRING HARNESS

(75) Inventors: Masayuki Doi, Yokkaichi-City (JP); Toshitsugu Morii, Yokkaichi-City (JP); Arisa Imatoku, Yokkaichi-City (JP)

Correspondence Address: HESPOS & PORCO LLP, 110 West 40th Street, Suite 2501, NEW YORK, NY, 10018, US

(73) Assignee: Sumitomo Wiring Systems, Ltd., Yokkaichi-City (JP)

(21) Appl. No.: 12/711,730

(22) Filed: Feb. 24, 2010

(30) Foreign Application Priority Data
Mar. 19, 2009 (JP) 2009-068713

(51) Int. Cl. H01B 7/00; H01B 19/00

(52) U.S. Cl. 174/72 A; 29/887

(57) ABSTRACT

A protective tape (20) is composed of a three-layer base material (21) formed by bonding two knitted fabrics (22) by a glue (23) applied in dots, and an adhesive layer (24) formed on the underside of the base material (21). The base material (21) distributes an external load to the two knitted fabrics (22) for relaxing a stress. The protective tape (20) is difficult to abrade and also has a good hand cutting property. The protective tape (20) is wound spirally around the outer circumferential surface of a cable bundle (10) with lateral edges thereof overlapped while being dispensed from a roll (30), and the adhesive layer (24) on the underside is bonded to the outer circumferential surface of the cable bundle (10).

### BACKGROUND OF THE INVENTION

1. Field of the Invention

The invention relates to a wiring harness provided with a protective member and to a method of producing a wiring harness.

2. Description of the Related Art

Japanese Unexamined Patent Publication No. 2000-353432 discloses the use of a corrugated tube to protect a cable bundle of a wiring harness to be installed in an automotive vehicle or the like. More specifically, an inner tape is wound around a bundle of cables. The taped bundle of cables then is inserted through a longitudinal slit in a slit corrugated tube and an outer tape is wrapped around the corrugated tube to prevent the slit from being opened. High costs are associated with the method of Japanese Unexamined Patent Publication No. 2000-353432 due to the many parts and the many operation steps. Additionally, an accommodation rate of the cable bundle in the corrugated tube is suppressed, for example, to 80% to suppress opening of the corrugated tube when the wiring harness is bent. Hence, the wiring harness is bulky to hinder space saving.

The invention was developed in view of the above situation and an object thereof is to provide a wiring harness with a protective member that reduces cost and saves space protecting a cable bundle.

### SUMMARY OF THE INVENTION

The invention is directed to a wiring harness with a protective tape wound around a cable bundle. The protective tape has a laminated base and an adhesive layer on the underside of the laminated base. The laminated base is formed by bonding two knitted and/or woven fabrics by a glue and/or adhesive. Thus, the base has a three-layer structure formed by the two fabrics that are bonded by the glue and/or adhesive. A load applied to the wiring harness is distributed mainly in the two fabrics to relax a stress. The protective tape has good abrasion resistance and can be cut easily by hand.

The protective tape can be mounted merely by being wound around the outer circumferential surface of the cable bundle and easily can be cut by hand. As a result, an operation of mounting the protective tape can be performed efficiently, a time required for mounting the protective member can be shortened and the number of parts can be reduced. Therefore, production cost can be reduced drastically.

The wound tape increases the diameter of the wiring harness to a minimum level, which contributes to space and weight saving saving.

The glue or adhesive for bonding the two fabrics of the protective tape may be applied in dots or in a discontinuous manner. Thus, a clearance is formed between the two fabrics and a load distribution function of the fabrics is fulfilled better. Further, the protective tape has a good sound deadening property, and the generation of noise is suppressed when the wiring harness contacts or rubs against a surrounding device due to vibration or the like. Further, the protective tape has good flexibility and can be wound more closely around the outer circumferential surface of the cable bundle even if the outer circumferential surface of the cable bundle is uneven or the cable bundle is bent.

The protective tape may be wound substantially spirally around the outer circumferential surface of the cable bundle with lateral edges thereof overlapped.

The protective tape may be wound around the outer surface of the cable bundle to define a tube with opposite lateral areas overlapped or abutting.

A thickness of the fabric on the top side and/or a thickness of the fabric on the under side are below about 1.0 mm. A thickness of the glue and/or adhesive may be about 0.05 to about 1.0 mm. A thickness of an adhesive layer is about 0.05 to about 1.0 mm. As a result, the total thickness may be equal to or below about 2.0 mm.

These and other features of the invention will be more apparent upon reading the following detailed description of preferred embodiments and accompanying drawings. Even though embodiments are described separately, single features may be combined to additional embodiments.

### BRIEF DESCRIPTION OF THE DRAWINGS

FIG. 1 is a section of a protection tape of a first embodiment of the invention.

FIG. 2 is a perspective view of a roll of the protective tape.

FIG. 3 is a side view showing a mode for winding the protective tape around a cable bundle.

FIG. 4 is a schematic diagram of an abrasion resistance tester.

FIG. 5 is a graph showing a result of the test of FIG. 4.

FIG. 6 is a schematic diagram of a sound deadening tester relating to hitting sound.

FIG. 7 is a graph showing a result of the test of FIG. 6.

FIG. 8 is a schematic diagram of a sound deadening tester relating to friction sound.

FIG. 9 is a graph showing a result of the test of FIG. 8.

FIG. 10 is a perspective view showing a mode for winding a protective tape around a cable bundle according to a second embodiment.

FIG. 11 is a perspective view showing a mode for winding a protective tape around a cable bundle according to a third embodiment.

### DETAILED DESCRIPTION OF THE PREFERRED EMBODIMENTS

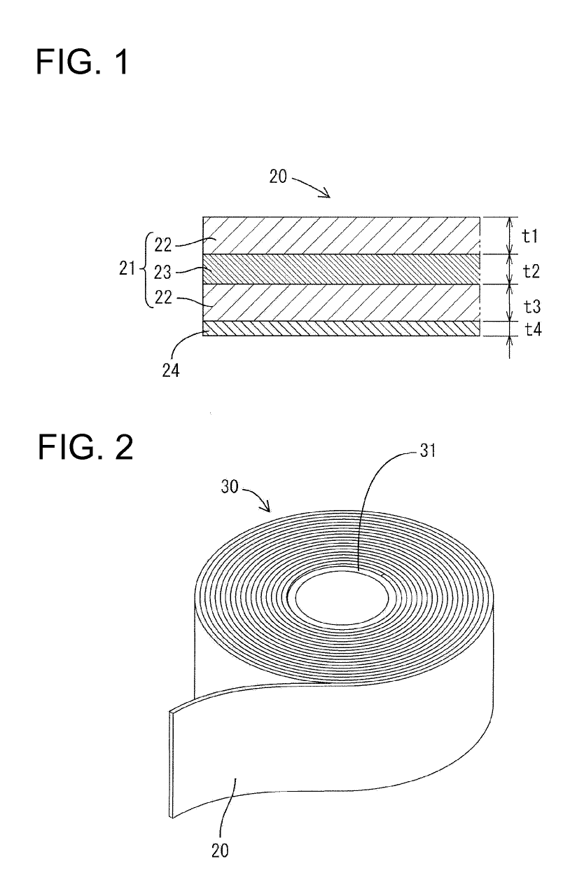

A first embodiment of the invention is described with reference to FIGS. 1 to 9. The first embodiment roughly has a protective tape 20 as a protective member wound around a cable bundle 10 of a wiring harness.

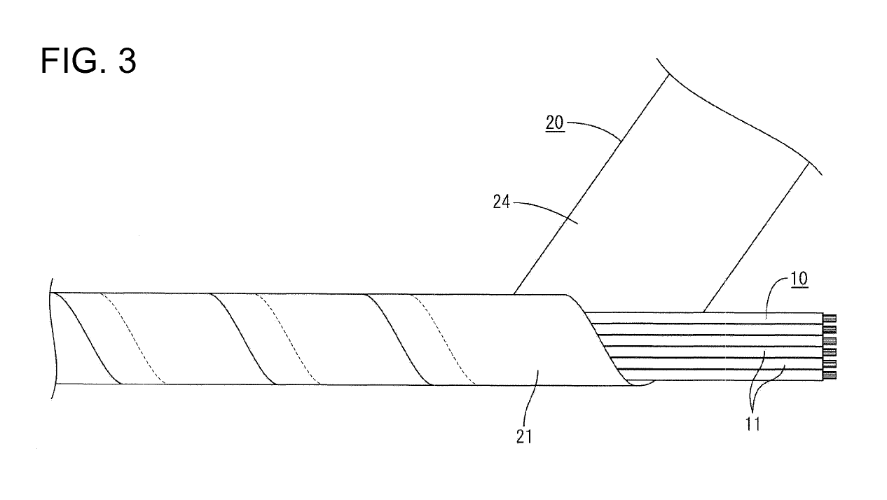

The cable bundle 10 has a plurality of insulated cables 11 and/or shielded cables bundle, as shown in FIG. 3.

As shown in FIG. 1, the protective tape 20 has a base material 21 and an adhesive layer 24 formed on the underside of the base material 21 to be held in contact with the outer circumferential surface of the cable bundle 10.

The base material 21 has a three-layer structure formed by bonding two knitted fabrics 22 by a glue or adhesive 23. Here, the “knitted fabric” is such that either warps or wefts are continuous strings of loops and the others are inserted through these loops. On the contrary, a “woven fabric” is a fabric formed by vertically or orthogonally intersecting warps and wefts.

The glue 23 preferably is a polyamide glue and preferably is applied in dots or on discontinuous areas having a small extension (such as not greater than about 4 mm2) between the two knitted fabrics 22. The glue 23 may be applied in a substantially regular pattern such as a lattice.

The adhesive layer 24 preferably is an acrylic adhesive or a rubber adhesive.

The thickness t1 of the knitted fabric 22 on the top side and the thickness t3 of the knitted fabric 22 on the under side preferably are below about 1.0 mm. The thickness t2 of the glue 23 is about 0.05 to about 1.0 mm and the thickness t4 of the adhesive layer 24 is about 0.05 to about 1.0 mm. The total thickness is equal to or below about 2.0 mm. In this embodiment, the total thickness is set at 1.0 mm.

The width of the protective tape 20 is below about 100 mm and, for example, is about 25 mm.

The protective tape 20 having such width (25 mm) and thickness (1.0 mm) is wound around a core element, such as a paper core tube 31, to define a roll 30, as shown in FIG. 2.

The protective tape 20 is wound manually around the cable bundle 10 of the wiring harness. In this embodiment, the protective tape 20 is dispensed from the roll 30 and is wound spirally around the outer circumferential surface of the cable bundle with lateral edges overlapped, as shown in FIG. 3. Thus, the adhesive layer 24 on the underside is bonded to the outer circumferential surface of the cable bundle 10. For example, about ¼ of the entire width is overlapped or about half the entire width is overlapped.

The protective tape 20 is cut or separated after being wound around over a specified length area of the cable bundle 10. In this regard, the base material 21 of the protective tape 20 is composed mainly of the knitted fabrics 22, and hence the protective tape 20 easily can be cut or separated by hand.

The abrasion resistance of the protective tape 20 was evaluated to assess the ability of the protective tape 20 to protect the cable bundle 10. The protective tape 20 would be considered to have good abrasion resistance if a hole is made to such an extent that the cable bundle 10 inside is exposed to the outside when the protective tape 20 is subjected to an external load.

The protective tape 20 is thought to be difficult to abrade since the base material 21 of the protective tape 20 has the three-layer structure by bonding the two knitted fabrics 22 with the glue 23. Thus, a load received from the outside is distributed mainly in the two knitted fabrics 22 and a stress is relaxed. Further, a load distribution function of the knitted fabrics 22 is fulfilled better since the glue 23 is applied in dots and a clearance is formed between the two knitted fabrics 22.

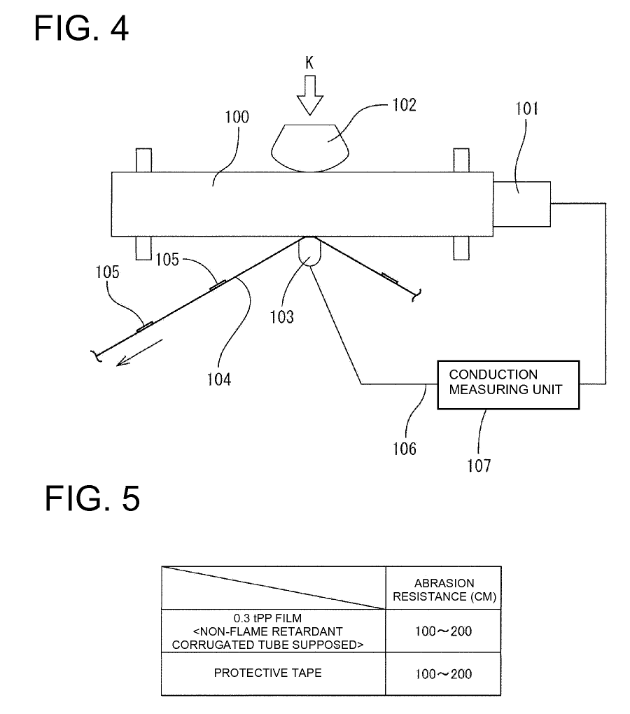

An abrasion resistance tester for automotive low-voltage cables specified by JIS was used as shown in FIG. 4 to assess the abrasion resistance of the protective tape 20. In this tester, a sample 100 is sandwiched between upper and lower metallic sandwiching portions 102, 103 while being wound around and bonded to the outer circumferential surface of a conductor 101 made of an aluminum tube, and an endless abrasive tape (JIS R6251 based article) is arranged to travel between the lower sandwiching portion 103 and the sample 100. Conductive portions 105 are provided at specified intervals (150 mm) on the abrasive tape 104. The lower sandwiching portion 103 and the conductor 101 are connected by a conductive line 106 and a conduction measuring unit 107 is provided at an intermediate position of the conductive line 106.

A load K (45 gf) is exerted to the upper sandwiching portion 102 and the abrasive tape 104 is moved at a specified speed (1500 mm/min). The sample 100 gradually abrades as the abrasive tape 104 travels, and eventually a hole is made therein. A conductive portion 105 of the abrasive tape 104 then contacts the conductor 101 via the hole and a current flows in the conduction line 106. The abrasive tape 104 is stopped when the current flow is detected by the conduction measuring unit 107. A longer traveling time of the abrasive tape 104 indicates more difficulty making a hole in the sample 100 and better abrasion resistance.

The test of the protective tape 20 of this embodiment showed that the abrasive tape 104 traveled 100 to 200 mm, as shown in FIG. 5.

The same test was performed on a PP (polypropylene) film having a thickness of 3 mm to assess abrasion resistance of a non-flame retardant corrugated tube used as a conventional protective member. A numerical value relating to abrasion resistance was confirmed to be 100 to 200 mm.

In other words, the tests indicated that the protective tape 20 of this embodiment had good abrasion resistance similar to the corrugated tube as a proven protective member for a wiring harness.

The protective tape 20 was assumed to have good sound deadening properties due to the three-layer structure formed by bonding the two knitted fabrics 22 with glue 23, and applying the glue 23 in dots to form a clearance between the two knitted fabrics 22.

A test relating to hitting sound and a test relating to friction sound were conducted to evaluate the sound deadening property of the protective tape 20.

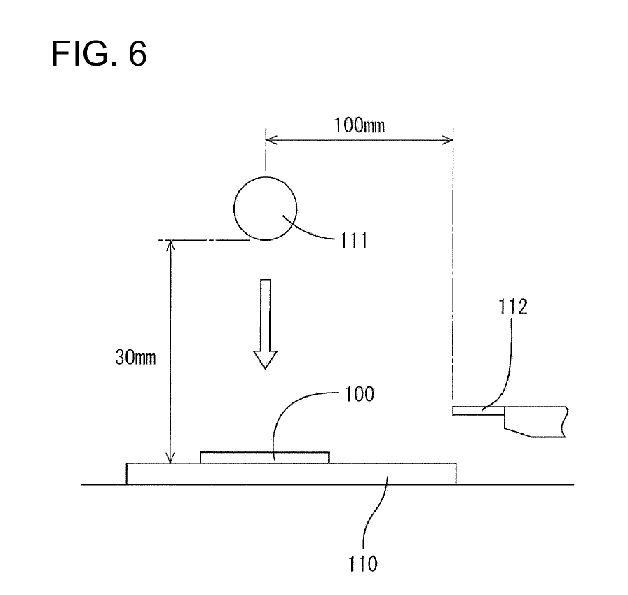

The test relating to hitting sound was carried out by placing a sample 100 on a test plate 110 made of a stainless steel plate (can also be a PP (polypropylene) plate or a PE (polyethylene) plate) having a thickness of 2 mm. An iron ball of 100 g was dropped on the sample 100 from a height of 30 mm. The hitting sound generated by the iron ball was measured by a measuring unit 112 at a position which is slightly above the test plate 110 and at a horizontal distance of 100 mm from the fallen position of the iron ball 111, as shown in FIG. 6.

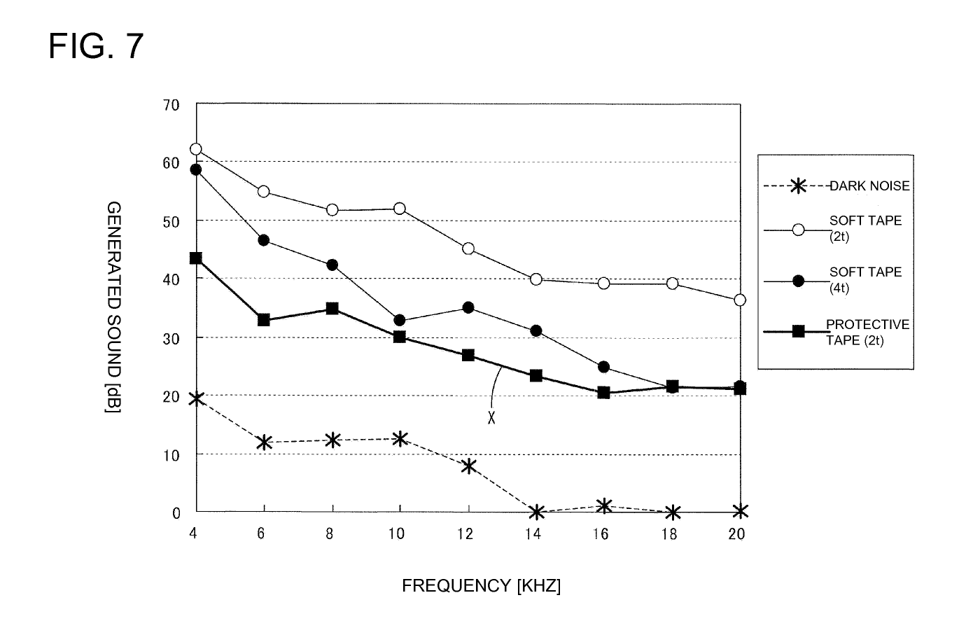

A test result of the protective tape 20 is shown by a characteristic line X of the graph of FIG. 7 and the hitting sound is 40 dB or below in an audible region (6 to 20 kHz). This indicates a sound deadening property equal to or better than that of a soft tape (urethane foam tape) having a thickness of 4 mm proven to have a good sound deadening property against hitting sound.

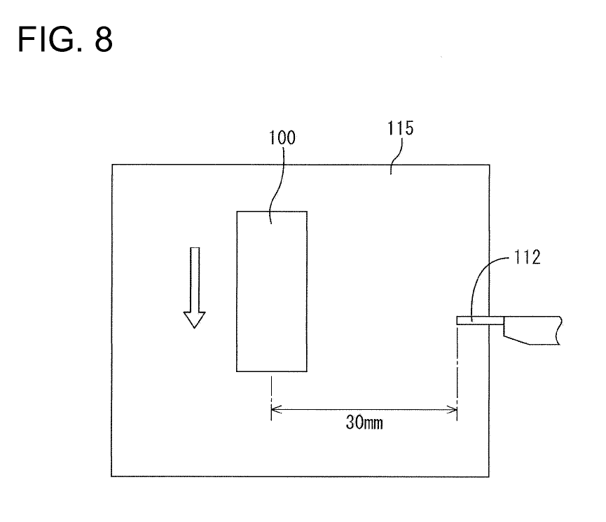

The test relating to friction sound was carried out by sliding the sample 100 manually in an arrow direction at a speed of about 20 mm/sec at a specified position on a test plate 115 made of a stainless steel plate (can also be a PP (polypropylene) plate or a PE (polyethylene) plate) having a thickness of 2 mm. Friction sound generated at that time was measured by the measuring unit 112 slightly above the test plate 115 and at a horizontal distance of 30 mm from the sliding position of the sample 100 as shown in FIG. 8.

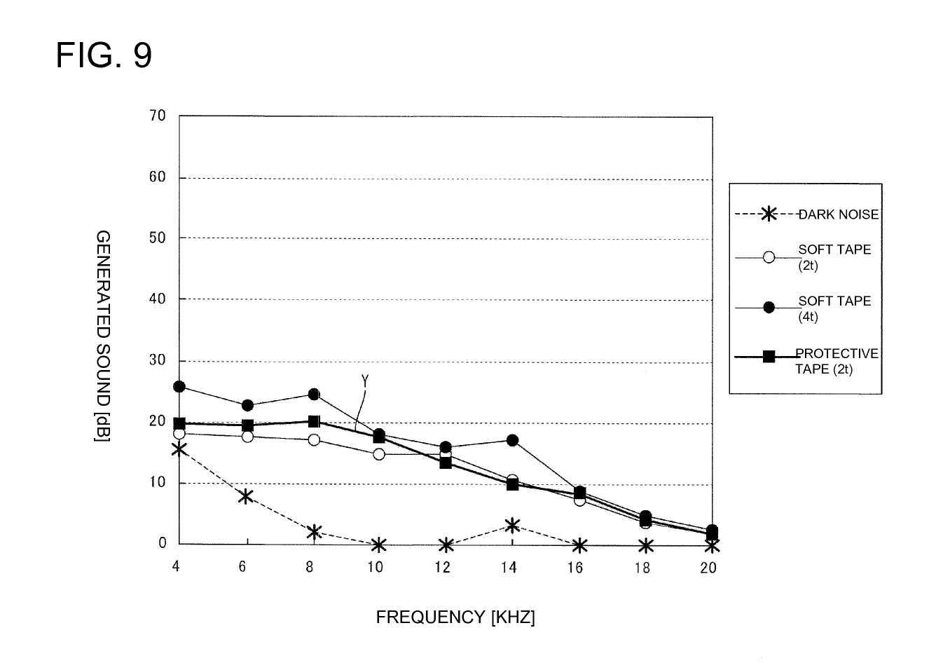

A test result of the protective tape 20 of this embodiment is as shown by a characteristic line Y in the graph of FIG. 9 and the friction sound is 20 dB or below in the audible region (6 to 20 kHz). This indicates a sound deadening property equal to or better than that of soft tapes (urethane foam tapes) having thicknesses of 2 mm and 4 mm proven to have a good sound deadening property against friction sound.

These two sound deadening tests confirm that the protective tape 20 has good sound deadening properties against hitting sound and friction sound.

The protective tape 20 has good flexibility since the base material 21 of the protective tape 20 has the three-layer structure as described above and the glue 23 is applied intermittently to form the clearance between the two knitted fabrics 22. Thus, even if the outer circumferential surface of the cable bundle 10 is uneven or the cable bundle 10 is bent, the protective tape 20 can be wound closely around the outer circumferential surface of the cable bundle 10.

The wiring harness formed by winding the protective tape 20 around the cable bundle 10 can obtain the following numerous advantages.

First, the protective tape 20 has abrasion resistance equivalent to the corrugated tube that is an acceptable protective member for the cable bundle 10. Thus, the protective tape 20 can fulfill its function of protecting the cable bundle 10.

Second, the protective tape 20 easily can be dispensed from the roll 30 and merely wound substantially spirally around the outer circumferential surface of the cable bundle 10 with the lateral edges or portions thereof overlapped.

Third, the protective tape 20 can be cut easily by hand after being applied to the cable bundle 10 in a specific manner. As a result, mounting the protective tape 20 as the protective member can be performed efficiently.

Fourth, the protective tape 20 preferably has a thickness of only about 1.0 mm. Thus, an increase in the diameter of the wiring harness is suppressed to a minimum, which contributes to space and weight saving.

Fifth, the protective tape 20 has a good sound deadening property. Thus, noise is suppressed when the wiring harness contacts or rubs against a nearby object due to vibration or the like.

Sixth, the protective tape 20 is very flexible and can be wound closely around the outer circumferential surface of the cable bundle 10 even if the outer surface of the cable bundle 10 is uneven or the cable bundle 10 is bent.

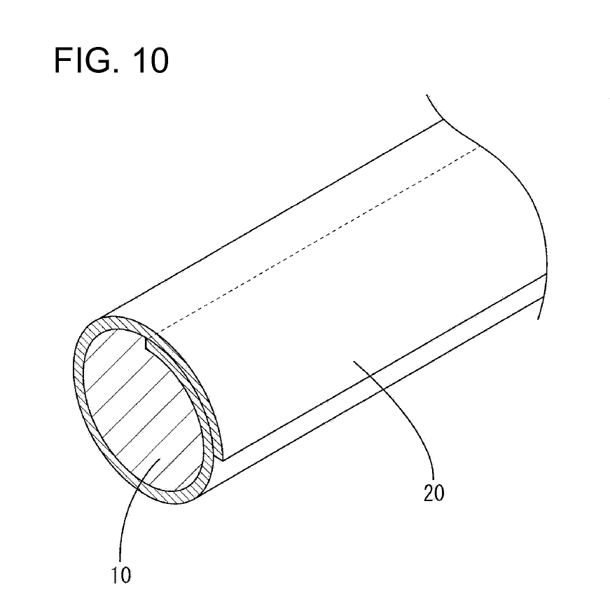

FIG. 10 shows a second preferred embodiment of the invention with another mode for winding the protective tape 20. In the second embodiment, the protective tape 20 is wound around the outer circumferential surface of the cable bundle 10 into a cylindrical shape with the opposite lateral edges overlapped. More specifically, the protective tape 20 is dispensed from the roll 30 (see FIG. 2), placed to extend substantially in a lengthwise direction of the cable bundle 10 and hand-cut after extending over a specified region. Thereafter, the protective tape 20 is wound into a cylindrical form with the opposite lateral edges thereof overlapped preferably by about ¼ of the entire width. The adhesive layer 24 on the underside then is bonded to the outer circumferential surface of the cable bundle 10. Effects similar to the first embodiment can be obtained for a wiring harness wound with the protective tape 20 in the mode of the second embodiment.

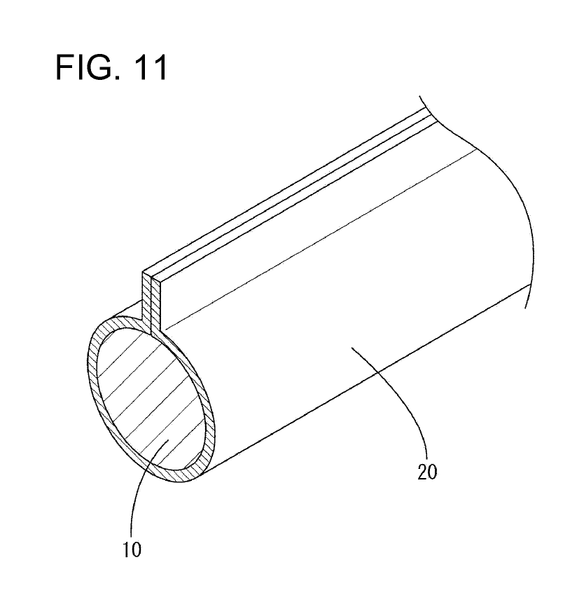

FIG. 11 shows a third preferred embodiment of the invention with still another mode for winding the protective tape 20. In the third embodiment, the protective tape 20 is wound around the outer circumferential surface of the cable bundle 10 substantially into a cylindrical shape with the inner surfaces of the opposite lateral edge portions put in face to face relationship and joined together.

More specifically, the protective tape 20 is dispensed from the roll 30 (see FIG. 2), placed to extend substantially in the lengthwise direction of the cable bundle 10 and hand-cut after extending over a specified region. Thereafter, the protective tape 20 is wound with the inner surfaces of the opposite lateral edges thereof put in face to face relationship and joined together. The adhesive layer 24 on the underside is bonded to the outer circumferential surface of the cable bundle 10. A dimension of a part where the inner surfaces of the opposite lateral edges are put together by applying the respective adhesives layers 24 to each other preferably is about ¼ of the entire width of the protective tape 20.

Effects similar to the first embodiment can be obtained also for a wiring harness wound with the protective tape 20 in the mode of the third embodiment.

The invention is not limited to the above described and illustrated embodiments. For example, the following embodiments are also included in the technical scope of the present invention.

The two fabrics of the base material of the protective tape are both knitted fabrics in the above embodiments. However, a knitted fabric and a woven fabric may be combined or two fabrics may be both woven fabrics.

If the glue for bonding the two fabrics has, for example, a relatively low hardness, it may be applied over the entire surface.

An adhesive may be used instead of the glue to bond the two fabrics. A preferable adhesive is an acrylic adhesive or a rubber adhesive.

What is claimed is:

1. A wiring harness, comprising:
a cable bundle (10) having an outer circumferential surface; and
a protective tape (20) having first and second fabrics (22) formed from knitted or woven materials bonded to one another by a glue or adhesive (23) and an adhesive layer (24) formed on a side of the first fabric (22) opposite the second fabric (22), the protective tape (20) being wound at least partly around the cable bundle (10) with at least part of the adhesive layer (24) being secured to the outer circumferential surface of the cable bundle (10).

2. The wiring harness of claim 1, wherein the glue or adhesive (23) for bonding the two fabrics (22) in the protective tape (20) is applied intermittently.

3. The wiring harness of claim 1, wherein a thickness (t1) of the first fabric (22) and a thickness (t3) of the second fabric (22) are less than about 1.0 mm, a thickness (t2) of the glue or adhesive (23) is about 0.05 to about 1.0 mm, a thickness (t4) of an adhesive layer (24) is about 0.05 to about 1.0 mm, and a total thickness is equal to or less than about 2.0 mm.

4. The wiring harness of claim 1, wherein the protective tape (20) is wound substantially spirally around at least part of the outer circumferential surface of the cable bundle (20) with lateral edges thereof overlapped.

5. The wiring harness of claim 1, wherein the protective tape (20) is wound around at least part of the outer circumferential surface of the cable bundle (10) into a cylindrical shape with opposite lateral edges thereof overlapped.

6. The wiring harness of claim 1, wherein the protective tape (20) is wound around at least part of the outer circumferential surface of the cable bundle (10) into a cylindrical shape with inner surfaces of opposite lateral edge regions secured in face to face relationship.

7. A method of forming a wiring harness, comprising:
providing a cable bundle (10);
providing a protective tape (20) having first and second fabrics (22) formed from knitted or woven materials bonded to one another by a glue or adhesive (23) and an adhesive layer (24) formed on a side of the first fabric (22) opposite the second fabric (22); and
at least partly winding the protective tape (20) around the cable bundle (10) so that the adhesive layer (24) is secured to an outer circumferential surface of the cable bundle (10).

8. The method of claim 7, wherein the glue or adhesive (23) bonding the first and second fabrics (22) of the protective tape (20) is applied in dots.

9. The method of claim 7, wherein the step of winding the protective tape (20) comprises winding the protective tape (20) substantially spirally around at least part of the outer circumferential surface of the cable bundle (20) with lateral edges of the protective tape (20) overlapped.

10. A method of claim 7, wherein the step of winding the protective tape (20) comprises winding the protective tape (20) into a substantially cylindrical shape with opposite lateral edges thereof overlapped.

11. The method of claim 7, wherein the step of winding the protective tape (20) comprises winding the protective tape (20) into a substantially cylindrical shape and securing portions of the adhesive layer (24) adjacent opposite lateral edge regions thereof in substantially face to face relationship.

12. The method of claim 7, wherein a thickness (t1) of the first fabric (22) and a thickness (t3) of the second fabric (22) are below about 1.0 mm, a thickness (t2) of the glue or adhesive (23) is about 0.05 to about 1.0 mm, a thickness (t4) of an adhesive layer (24) is about 0.05 to about 1.0 mm, and a total thickness is equal to or below about 2.0 mm.
